(19) United States
(12) Patent Application Publication
(10) Pub. No.: US 2014/0173692 A1
(43) Pub. Date: Jun. 19, 2014

(54) Bring your own device system using a mobile accessory device

(71) Applicants: Sudharshan Srinivasan, Fremont, CA (US); Jai Kumar, Cupertino, CA (US); Kothandraman Ramchandran, Fremont, CA (US)

(72) Inventors: Sudharshan Srinivasan, Fremont, CA (US); Jai Kumar, Cupertino, CA (US); Kothandraman Ramchandran, Fremont, CA (US)

(21) Appl. No.: 13/694,588

(22) Filed: Dec. 15, 2012

(51) Int. Cl. H04L 29/06

(52) U.S. Cl. CPC H04L 63/08
USPC 726/4

(57) ABSTRACT

A BYOD solution using a combination device is described. This combination device is comprised of an employee owned smart mobile device (31) and an accessory device (32) used together using a wireless local area network (46).

Mobile device (31) is an employee owned device that is used as a remote display of display output of enterprise certified applications (49) executing at accessory device (32).

Accessory device (32) is comprised of a general purpose processor, optional graphics processing unit, one or more local wireless area network interfaces that connect the mobile device (31) to accessory device (32), and one or more Internet network interfaces (52) that connect accessory to enterprise network.

The BYOD accessory device acts as a secure hardware gateway to connect the mobile device to corporate network.

The BYOD accessory device also acts as a secure execution environment of corporate applications in addition to providing secure storage of corporate data.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

The present invention generally relates to bring your own device solutions and specifically relates to bring your own device solution using a mobile accessory device.

2. Prior Art Us Patent

There are plenty of bring your own device (BYOD) solutions in prior art. BYOD solutions enable employee purchased smart devices such as smartphones and tablets to be used at the workplace.

These solutions are broadly categorized as mobile device management solutions (MDM). All such MDM solutions are software solutions that offer several features needed to manage employee owned devices at work. But all such software solutions lack in several aspects that are to be addressed in an information technology (IT) environment.

Below are ten issues where software based MDM solutions are insufficient.

First a BYOD solution should address employee privacy issues where personal data should be protected against accidental or purposeful breach from the IT department. Most corporate organization (enterprise) policies will mandate daily backup and audit of devices that are used for work and are controlled by IT department. But a malicious employee of the IT department can have access to employees personal data leading to employee privacy issues. This could also occur when an employee owned device has a problem running corporate software and needs to be physically handed over to IT department to fix.

This cannot be solved by a software based MDM solution since such solutions are implemented as software in employee owned devices and cannot partition the entire smart device in hardware so that only the work related hardware can be handed over to IT department.

Second, a BYOD solution should provide a way for an employee to choose a cellular network operator of their choice other than what an enterprise would offer. Most enterprises have specific requirements for cellular phone and data access plans. They may get bulk discounts or may like particular features of a certain operator. But an employee may want to choose a different operator due to better signal strength around his home area or to communicate with friends and family members using a particular operator.

This cannot be solved by a software based MDM solution since a single modem device can only connect to a single cellular wireless network operator. This is a hardware limitation that a software MDM solution cannot solve.

Third, a BYOD solution should provide end to end hardware and software control to the IT department. Otherwise an IT department cannot guarantee end to end security. A user may download applications from unknown or unverified sources and they may contain malware or virus programs.

This cannot be solved by a software based MDM solution since a user may install software from untrusted sources or may connect to untrusted public wireless networks. There is no way for a software MDM solution to partition a wireless network connection into two parts, one for work and one for personal use.

Fourth, a BYOD solution should NOT introduce additional maintenance problems for IT departments, as IT budgets are already constrained in today's enterprises. Maintaining just one laptop device with one operating system is in itself a big problem for IT departments. Maintaining multiple devices with multiple revisions of operating systems for each employee is an open ended problem consuming enormous time and resources.

This cannot be solved by a software based MDM solution since MDM solutions only provide for maintaining the access control of devices that connect to corporate network, but there is no way a MDM solution can keep track of operating system issues, or in house software problems or hardware issues of ever evolving new set of devices.

Fifth, a BYOD solution should prevent data leaks from an employee device either inadvertently or on purpose. An employee could download a confidential document into a BYOD device and then copy the document into a SD card or copy it to an internet file server. This may result in confidential data being exposed and not protected properly.

This cannot be solved by a software based MDM solution since an employee owned device cannot be partitioned such that the employee does not have access to one partition completely since an employee owned device has full permissions for an employee.

Sixth, a BYOD solution should not use so many resources on employee owned device that an employee finds his/her device rendered slow or less than adequate for personal activity. For example, some enterprises may partition a device into two parts, effectively freezing the amount of disk space an employee can use for personal use. But this would mean that an employee would get to store lesser number of pictures or videos on their device.

This cannot be solved by a software based MDM solution since if an enterprise loads up too much security software, and other in house software in addition to standard messaging software such as email, instant messaging, social enterprise software, office suite etc., the amount of space required on an employee device could be significant. Since there is only limited disk space which can get filled quickly by an employee by recoding videos and taking pictures, an employee may be disgruntled to find out that a lot of space is taken over by the corporate partition.

Seventh, a BYOD solution should not add unnecessary usability issues for an employee. For example enterprises require eight digit passwords for any mobile device that connects to corporate networks, but this could be very problematic for an employee owned device that is being used for personal use such as for reading messages from social media sites like Facebook. Such messages are received frequently and an employee may not want to enter a long password each time they need to accesses their devices to read messages.

This cannot be solved by a software based MDM solution since most smart phones in use today only offer a single user account and there is no way to setup separate passwords for personal and corporate accounts.

Eighth, a BYOD solution must provide for E-Discovery rules that state that if a company gets into a legal problem, all data associated with the company on all devices should be turned in as evidence. But if the devices are employee owned and they can make copies of data in other devices for later use, it will be very hard to track down which devices contain what data in order to honor such rules to the fullest extent.

This cannot be solved by a software based MDM solution that is installed on each smart device an employee owns. A smart device that an employee owns cannot be partitioned such that an employee cannot make copies of corporate data as the root user or the user with administrative privileges is the employee and not the IT department. So the employee will have access to all data and he can easily make copies of such data.

Ninth, a BYOD solution should NOT introduce additional burden on enterprise software developer teams for providing and maintaining in house software on many platforms and operating systems. This will add to IT budget significantly.

This cannot be solved by a software based MDM solution since MDM solutions provide for maintaining multiple smart devices but do not provide a portability layer that enables applications to execute on several operating systems and hardware architectures.

Tenth, a BYOD solution should provide highly interactive experience with the security of a virtual desktop infrastructure solution (VDI). VDI infrastructure makes sure that employees cannot download entire documents onto their personal devices and can view documents only one page at a time. This enables additional security on their device.

This cannot be solved by a software based MDM solution since MDM solutions can at best provide access to a VDI solution from a corporate network. But VDI solutions take up enormous bandwidth and are highly unusable in wireless data networks with high and unpredictable latency and bandwidth.

Some MDM solutions enable a user to partition an employee device into two partitions. One partition will enable work related activity and the other partition will enable personal activity. Such solutions are called container based MDM solutions. Although these solutions give an employee the benefit of using a single device for both work and personal use, they do not offer sufficient protection against employee privacy issues as mentioned above.

Hence it can be seen that software based MDM solutions are inadequate in addressing the above mentioned issues.

As can be seen from above, all known prior arts suffer from some limitations in offering a solution to address the above mentioned issues for providing a complete BYOD solution.

### BACKGROUND OF THE INVENTION

### Objects and Advantages

Accordingly, several objects and advantages of the present invention are:
a) to provide a BYOD solution that addresses employee privacy issues.
b) to provide a BYOD solution that enables an employee to choose a different wireless operator that what is provided by an enterprise.
c) to provide a BYOD solution that enables end to end hardware and software control by IT department to guarantee security.
d) to provide a BYOD solution that does not impose additional maintenance issues for IT department.
e) to provide a BYOD solution that minimizes data leaks of corporate data.
f) to provide a BYOD solution that does not consume too many resources of employee owned mobile device.
g) to provide a BYOD solution that does not add unnecessary usability issues.
h) to provide a BYOD solution that enables full compatibility with E-Discovery rules.
i) to provide a BYOD solution that does not add to the burden of software development teams.
j) to provide a BYOD solution that provides the best application performance and the best security as in a VDI solution but without the VDI solution performance overheads.

### SUMMARY

In accordance with present invention a hardware based BYOD solution is described.

This hardware based BYOD system comprises of a hardware accessory device that is coupled to a smart device using local wireless network connection.

This hardware accessory is further referred to as a BYOD accessory and the smart device is further referred to as a mobile device. The combination of mobile device and BYOD accessory will be further referred to as a combination device.

An employee who wants to use his/her mobile device at work is given a BYOD accessory by an enterprise to use as a gateway into the corporate network that also acts as a secure execution environment for corporate applications, and a secure storage of corporate data.

Hence an employee can get into corporate network on their mobile device only through this BYOD accessory and all corporate applications such as email client, document viewers or other in house software applications from the enterprise are installed on the BYOD accessory.

The BYOD accessory acts as a gateway between the mobile device and corporate network. The BYOD accessory has a one or more local wireless interfaces to connect to the mobile device and one or more wireless interfaces to connect to the corporate network.

The BYOD accessory device also has a general purpose processor (GPP) and an optional graphics processing unit (GPU) to execute an operating system and IT certified applications.

The BYOD accessory device does not have a large bitmapped display that can display all the contents of all software applications. The BYOD accessory may have a small display just for message notifications.

Since the BYOD accessory does not have a large display, graphical output of each of the applications executed on the GPP and/or GPU of BYOD accessory are exported in real time to the display of the mobile device using a remote graphics application such as virtual network computing (VNC) or other optimized forms of remote graphics rendering technology that transfer graphical commands instead of bitmaps.

This BYOD accessory can be affixed to a back of any smart device such as a smartphone with magnetic adhesion or other forms of adhesion. The BYOD accessory will work with any form factor smart device including smartphones, tablets, laptops and smart TVs as physical connection is optional between the mobile device and the BYOD accessory. Affixing the BYOD accessory behind a smartphone enables the two devices to be combined into a single form factor and hence treat the combination device as a single device.

Some employees carry two independent phones to solve the problem. But the combined weight of a BYOD accessory device with the mobile device will always be lesser than carrying two independent phones that each has a full sized display. Carrying two independent devices means that application output has to be viewed on two different screens, which adds to usability issues since the user may want to use the best screen display, such as an iPhone retina display for both work and personal use. This is not possible if the work provided phone is an older generation smart phone.

In addition to above mentioned advantages of the combination device over carrying two smart devices one for work and one for personal use, the combination device offers several other advantages over software based MDM solutions.

First, employee privacy issues do not arise since all corporate data will reside on the BYOD accessory in an encrypted form and corporate IT department can only access BYOD accessory device and its storage and not the main mobile device that it may be used with, since only the mobile device can initiate a connection into BYOD device and operate the BYOD accessory using the display of mobile device but not the other way around.

Second, the BYOD accessory has its own hardware cellular modem that can connect to any cellular operator, enabling enterprises to choose enterprise friendly cellular network operators on BYOD accessory and enabling employees to choose a separate cellular operator for their personal use on their mobile device.

Third, the BYOD accessory is in full control of IT department and hence IT department can provide end to end control of both hardware and software for an enterprise. Since IT department has full control, an employee cannot download programs from untrusted sites onto the BYOD accessory or connect to un-trusted wireless networks.

Fourth, the BYOD accessory enables IT departments to use just one device model for all employees, thus reducing maintenance costs that occur by maintaining multiple devices and operating systems as in BYOD solutions of prior art.

Fifth, the BYOD accessory enables IT departments to lock in data such that an employee can only see the data one screen at a time just like a VDI solution. This prevents an employee from downloading an entire file and copying to other devices. The BYOD accessory will also not have a SD card holder to enable copying data out of this device easily. Hence data leaks are minimized.

Sixth, the BYOD accessory is a separate piece of hardware with its own application and storage space, and does not use any disk space of the mobile device expect for screen sharing application output. Hence an employee does not have to worry about corporate data and applications taking up too many resources from their mobile device.

Seventh, the BYOD accessory will have its own access mechanism with a corporate guideline based password system that will not impact an employee mobile device login. Anytime a user wants to look at corporate data, they would have to type in a long password defined by corporate guidelines. But when looking at personal messages, user may not even need a password on their mobile device. A configurable timeout interval maybe set for the BYOD accessory to activate the long password prompt. Hence additional usability issues are not introduced for the mobile device.

Eight, the BYOD accessory is a separate piece of hardware and hence can be handed over to IT department for E-Discovery purposes, or for maintenance purposes. There can be no personal data on BYOD device and there can be no unverified applications on this device. Hence this device will be always be E-Discovery compatible. IT departments do not have to worry which other employee devices may have sensitive corporate data.

Ninth, the BYOD accessory is a separate piece of hardware with its own operating system and corporate certified applications. Hence an enterprise developer of in house software needs to worry about only one platform and not several platforms and devices.

Tenth, the BYOD accessory will provide highly interactive application performance with the security of a VDI solution. This is because all corporate applications programs are executed on BYOD accessory and graphical output of these applications is exported to display of mobile device. Hence all application processing is done locally at the user location instead of at a server like in a conventional VDI solution. This enables applications to run with almost native like performance without the latency and bandwidth overheads of a conventional server based VDI solution.

Hence it can be seen that the combination device comprised of a mobile device and a BYOD accessory provides the best of both worlds BYOD solution. Security of a VDI solution where a user is shown only one screen of data at a time, performance of a native application where user can interact with the application with least latency, and does not suffer from user privacy issues and other issues mentioned above. This combination device is also better than carrying two devices with two different user interfaces.

### DRAWINGS

### Figures

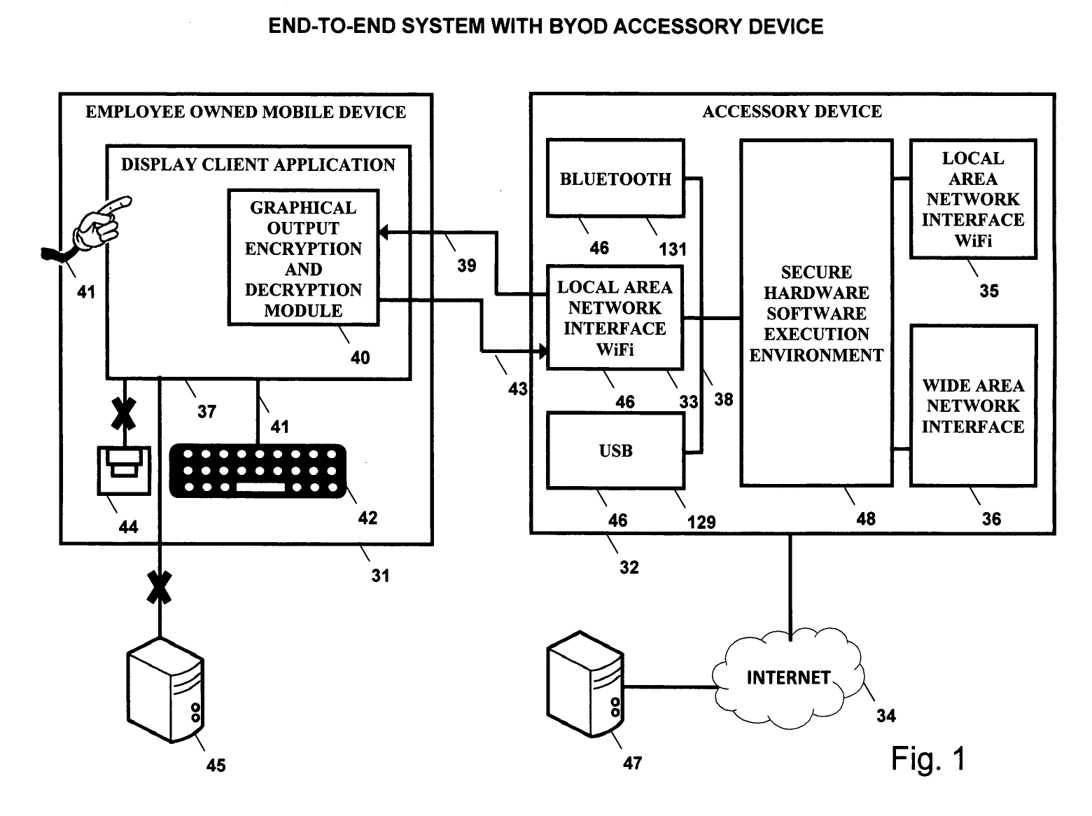

FIG. 1 shows end to end system where an employee owned mobile device is combined with an accessory device.

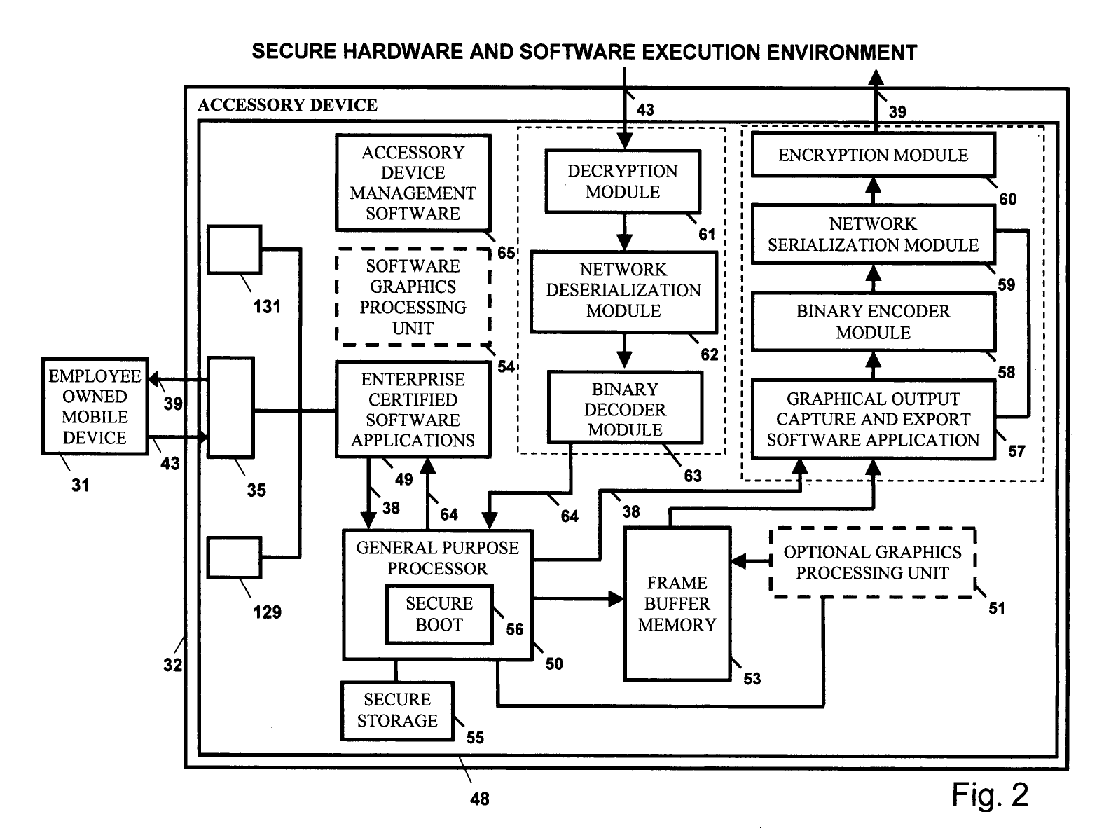

FIG. 2 shows secure hardware software execution environment of accessory device.

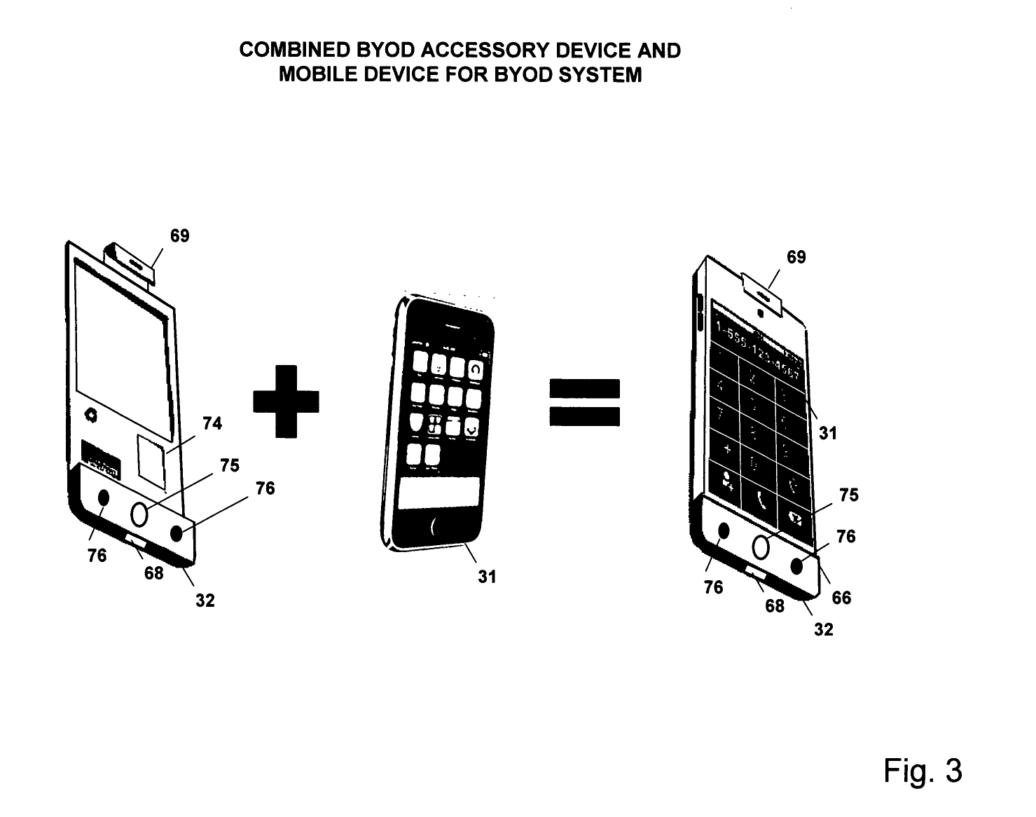

FIG. 3 shows accessory device coupled to mobile device

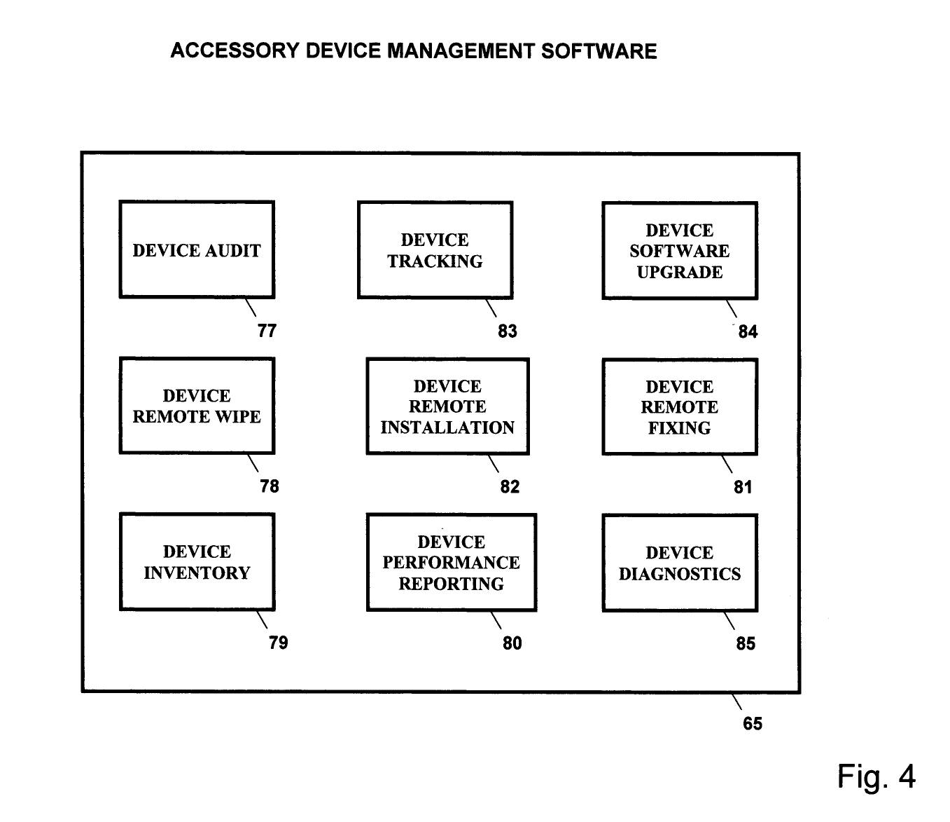

FIG. 4 shows components of accessory device management software

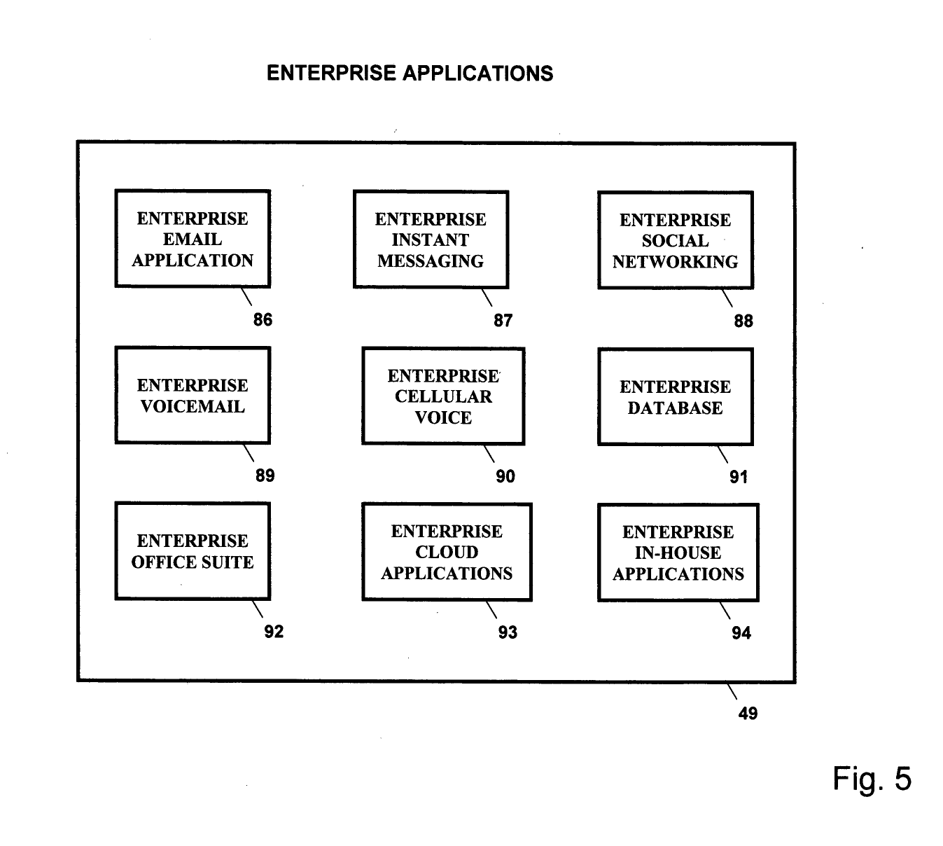

FIG. 5 shows enterprise applications.

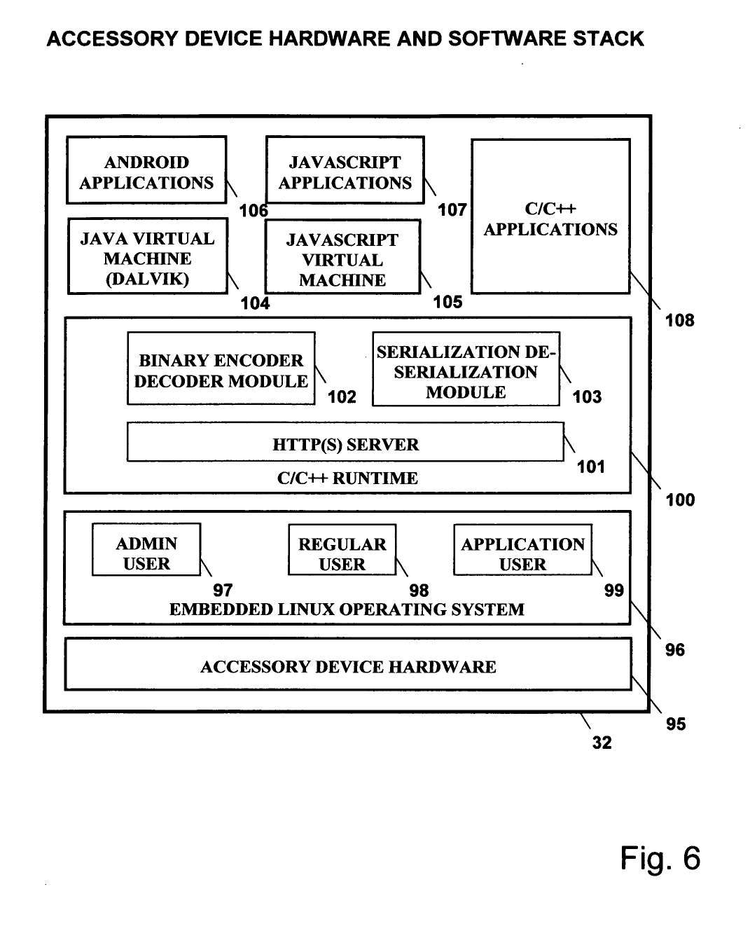

FIG. 6 shows hardware and software stack of accessory device.

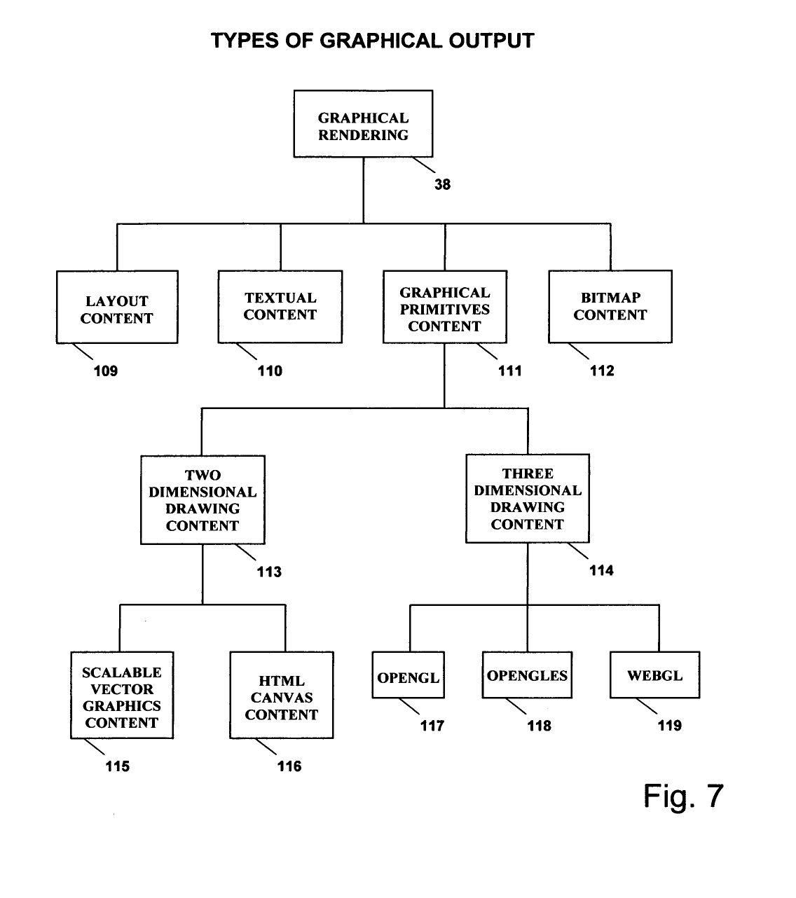

FIG. 7 shows different types of graphical output.

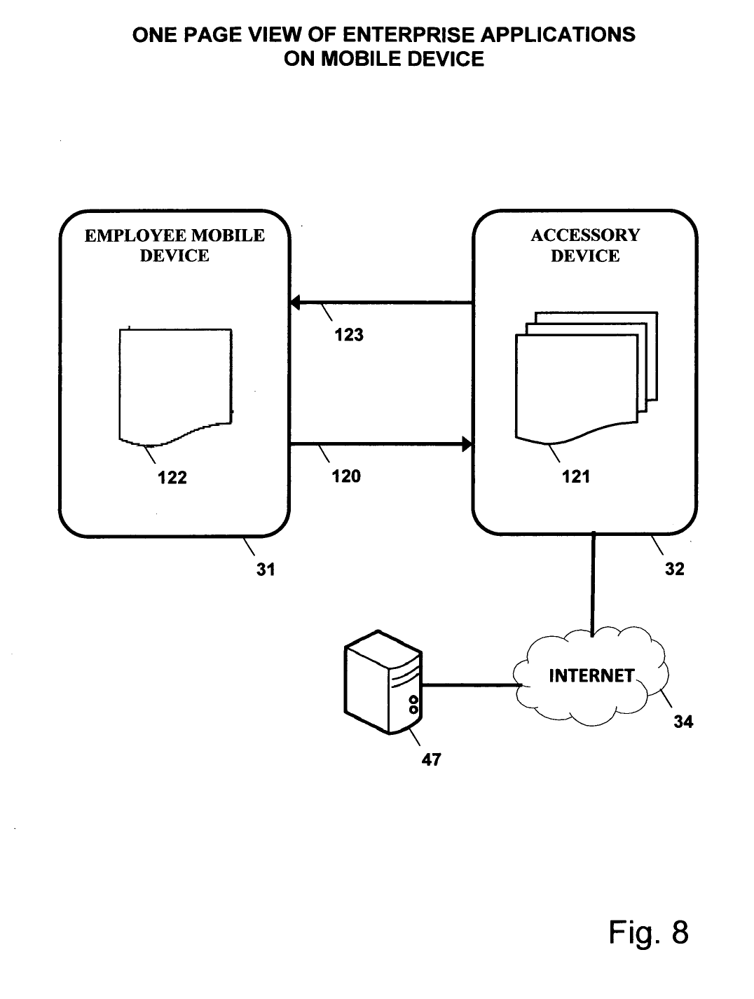

FIG. 8 shows how accessory device allows only one page view of enterprise applications on mobile device.

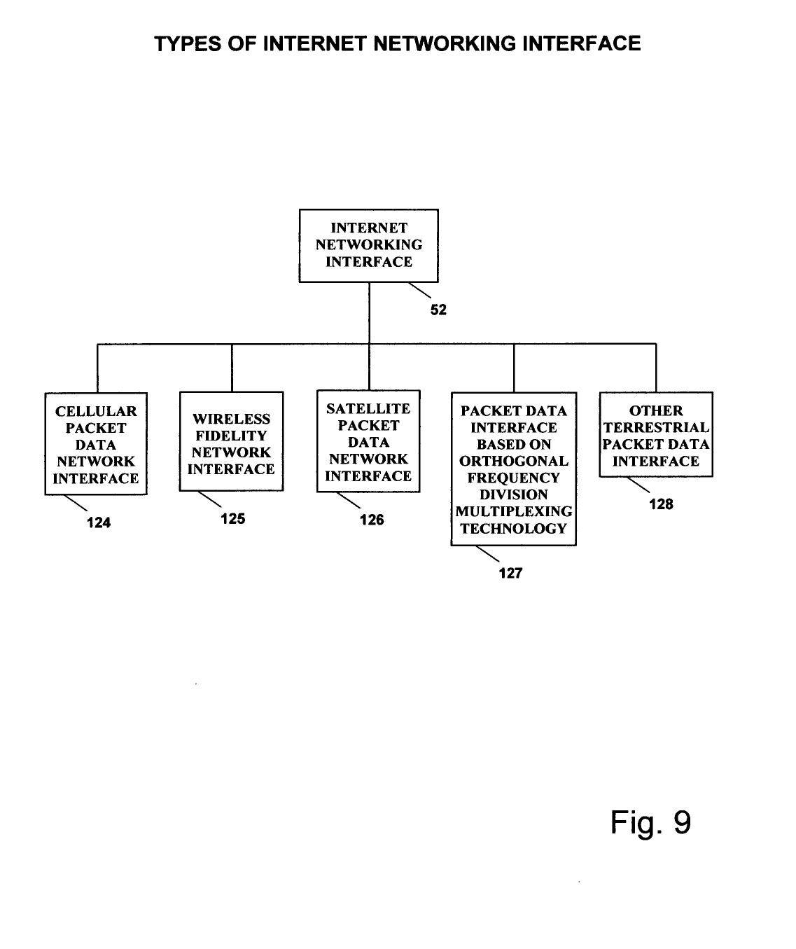

FIG. 9 shows internet networking interface.

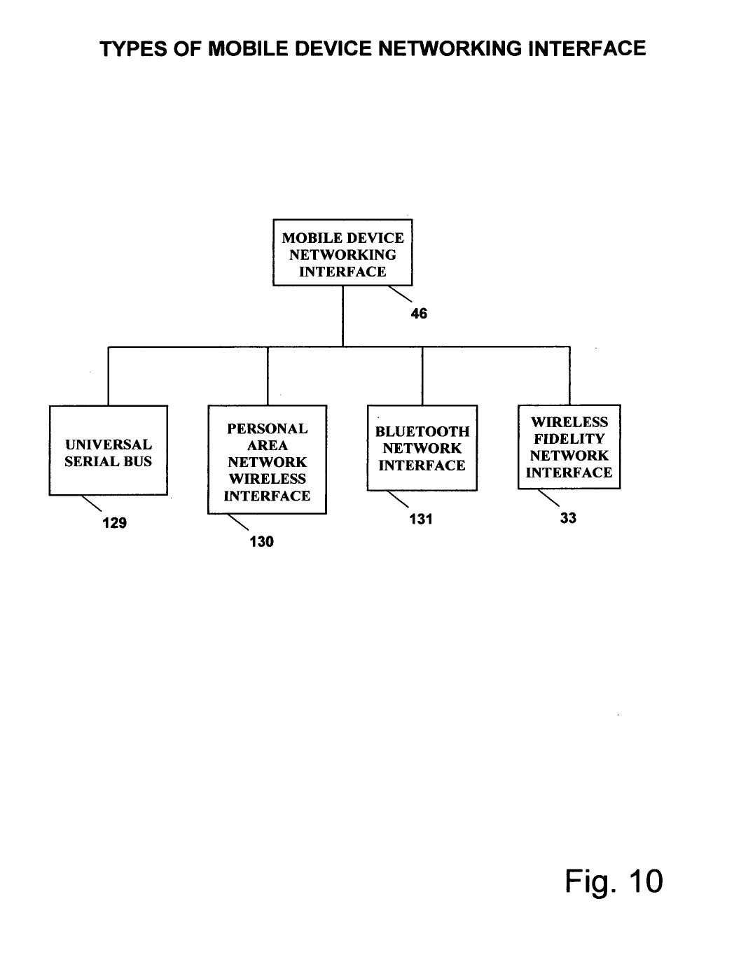

FIG. 10 shows mobile device networking interface.

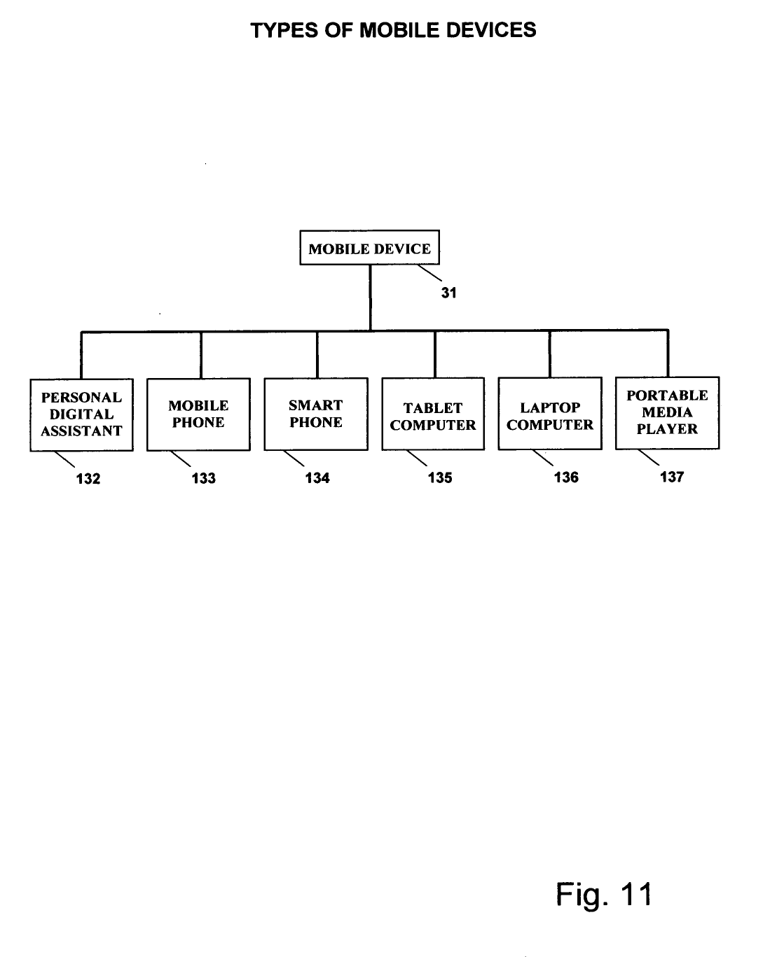

FIG. 11 shows mobile device types.

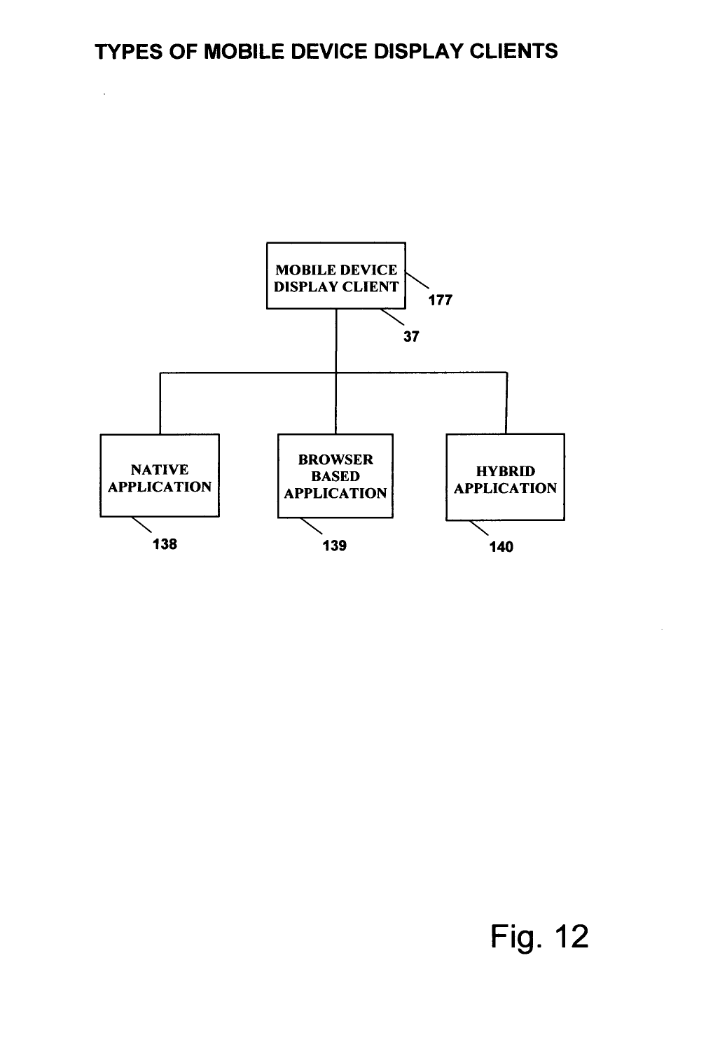

FIG. 12 shows mobile device display client.

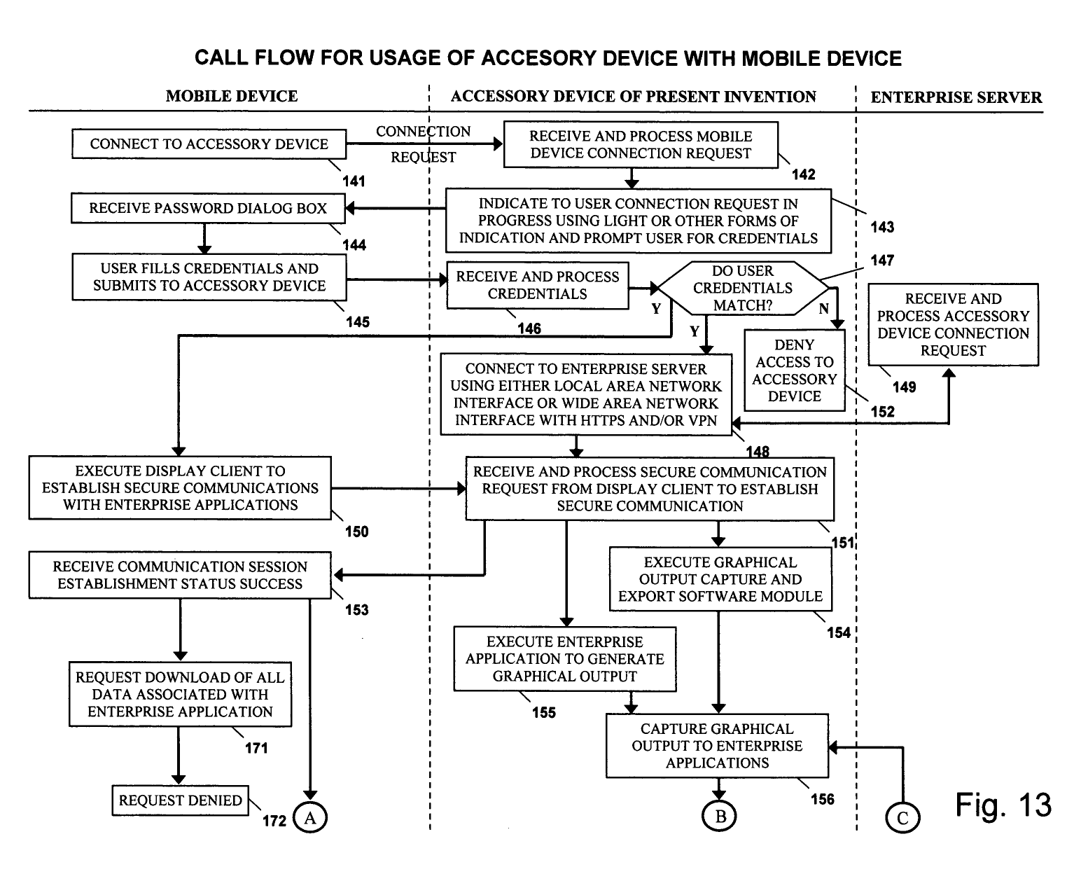

FIG. 13 illustrates the call flow sequence of a user on mobile device interacting with accessory device.

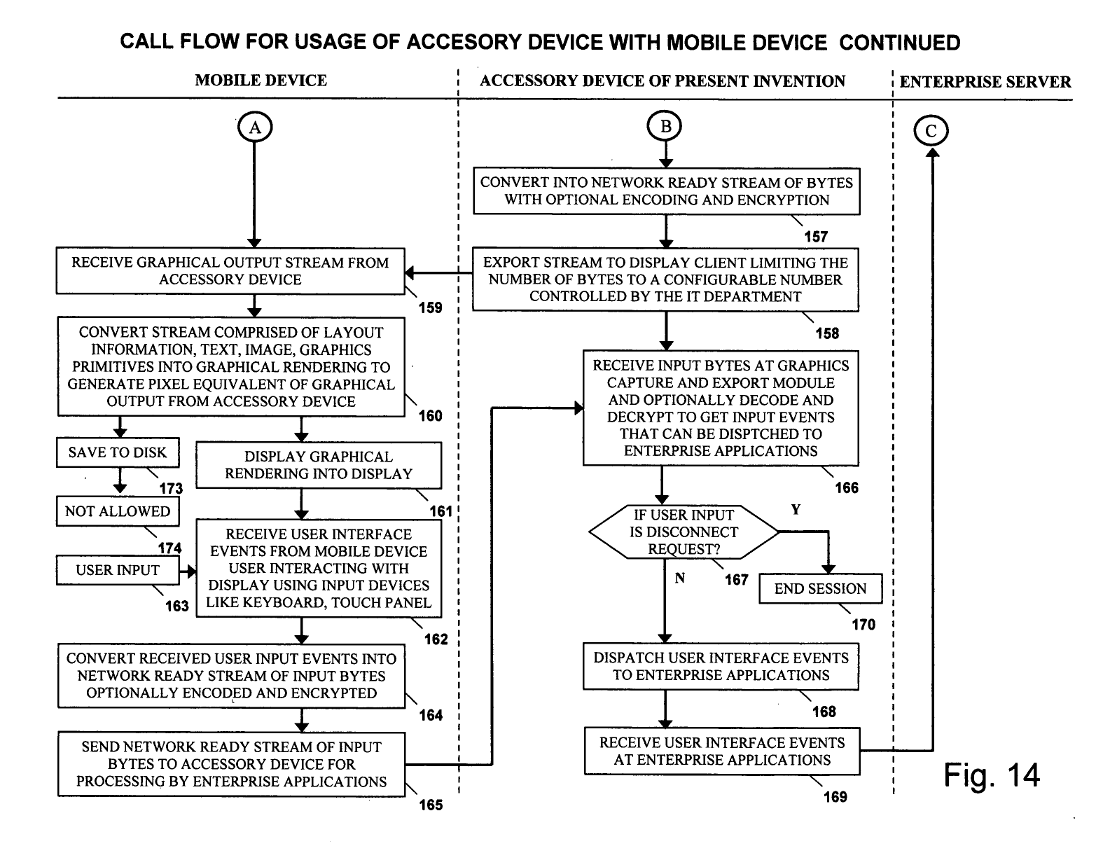

FIG. 14 illustrates continuation of call flow sequence of a user on mobile device interacting with accessory device.

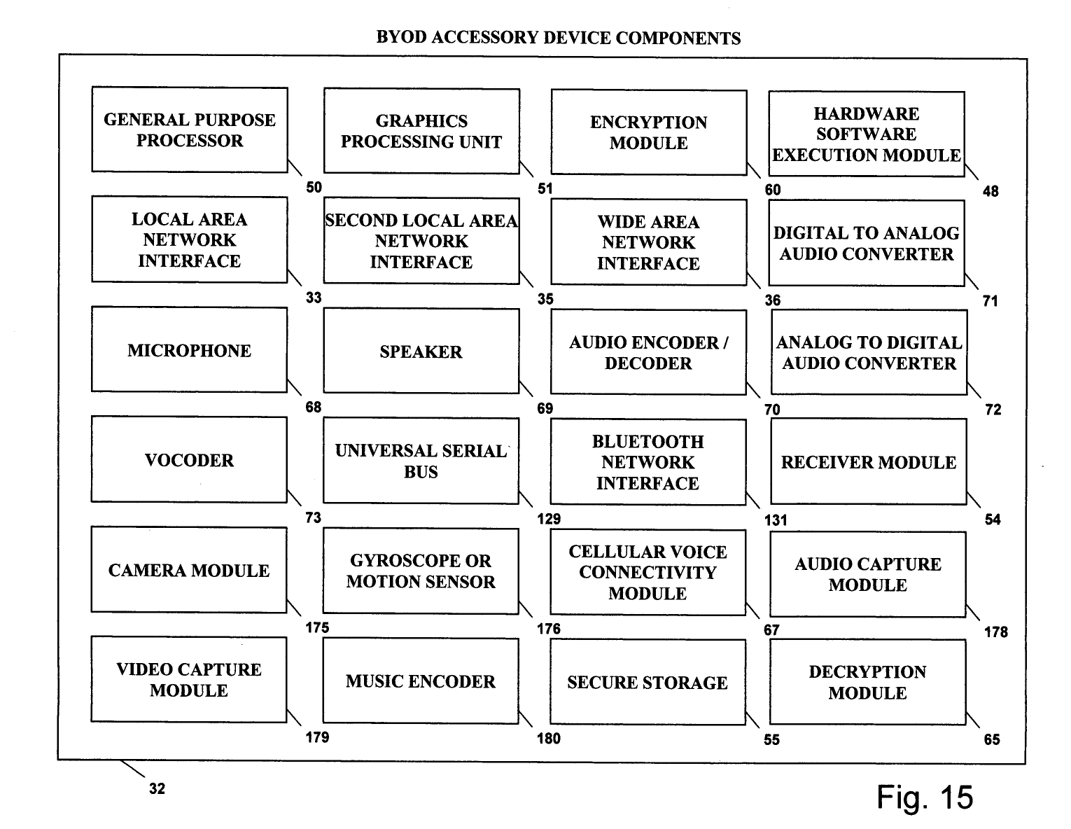

FIG. 15 shows details of accessory device.

### DRAWINGS

### Reference numerals

31 employee owned mobile device
32 accessory device
33 local area network interface
34 Internet
35 enterprise connecting second local area network interface
36 enterprise connecting wide area network interface
37 enterprise certified display client software application
38 graphical output
39 encrypted output stream from accessory
40 Encryption and decryption module
41 user interface input events
42 keyboard
43 mobile device encrypted output stream
44 mobile device local storage
45 external servers
46 local area network interfaces
47 enterprise server
48 secure hardware software execution environment
49 enterprise applications
50 general purpose processor
51 optional graphics processing unit
52 Internet networking interface
53 frame buffer memory
54 software graphics processing unit
55 secure storage
56 secure boot feature
57 graphical output capture and export software application
58 binary encoder module
59 network serialization module
60 encryption module
61 decryption module
62 network deserialization module
63 binary decoder module
64 copy of user interface events
65 accessory device management software
66 a combined device
67 cellular voice connectivity
68 microphone
69 speaker
70 audio encoder/decoder
71 digital to analog audio converter
72 analog to digital audio converter
73 vocoder
74 subscriber identity module (SIM) card holder
75 on and off power button and call accept and reject button
76 light emitting diode indicators
77 device audit
78 remote wipe
79 device inventory
80 device performance reporting
81 device remote fixing
82 device remote installation
83 device tracking
84 device software upgrade
85 device diagnostics
86 enterprise email application
87 enterprise instant messaging application
88 enterprise social networking application
89 enterprise voicemail application
90 enterprise cellular voice application
91 enterprise database application
92 enterprise office suite application
93 enterprise cloud based application
94 enterprise in house developed application
95 accessory device hardware
96 embedded linux
97 administrator user
98 regular user
99 application user
100 C/C++ runtime environment
101 HTTP(S) server
102 binary encoder/decoder module
103 serializer and de-serializer module
104 java virtual machine
105 javascript virtual machine
106 android applications
107 javascript applications
108 Native applications written in C/C++
109 layout content
110 textual content
111 graphical primitives content
112 bitmap content
113 two dimensional graphics content
114 three dimensional graphics content
115 scalable vector graphics content
116 HTML canvas graphics
117 opengl
118 opengeles
119 webgl
120 page request
121 multiple pages of data
122 single page
123 page response
124 cellular packet data network interface
125 wireless fidelity network interface
126 satellite packet data network interface
127 packet data interface based on orthogonal frequency division multiplexing technology
128 other terrestrial packet data interface
129 universal serial bus
130 personal area network wireless interface
131 Bluetooth network interface
132 personal digital assistant
133 mobile phone
134 smart phone
135 tablet computer
136 laptop computer,
137 portable media player
138 native application
139 a browser based application
140 hybrid application
141 step
142 step
143 step
144 step
145 step
146 step
147 step
148 step
149 step
150 step
151 step
152 step
153 step
154 step
155 step
156 step
157 step
158 step
159 step
160 step
161 step
162 step
163 step
164 step
165 step
166 step
167 step
168 step
169 step
170 step
171 step
172 step
173 step
174 step
175 camera module
176 gyroscope or motion sensor
177 enhanced display client
178 audio capture module
179 video capture modules
180 a music encoder

### DETAILED DESCRIPTION OF PREFERRED EMBODIMENT

In the following description, a BYOD system is described that enables employee owned devices to be used at an enterprise using an accessory device of present invention providing a secure execution environment for corporate applications and a secure gateway into enterprise networks.
Then a method enabling use of an employee owned mobile device at an enterprise using the accessory device is described which is followed by details of the internals of the accessory device of present invention.

FIG. 1 shows end to end system where an employee owned mobile device 31 is coupled with an accessory device 32 of present invention using a local area network interface 33. Accessory device 32 is coupled to Internet 34 using either an enterprise connecting second local area network interface 35 or enterprise connecting wide area network interface 36.

There can be one or more local area network interface connections between mobile device 31 and accessory device 32, and there can be one or more network interfaces connections between accessory device 32 and Internet 34.

Mobile device 31 executes an enterprise certified display client software application 37 that enables display of graphical output 38 of enterprise certified applications executing at accessory device 32.

Display client application 37 is enterprise certified so that only display client application 37 can display contents of graphical output 38 and no other display client application can display contents of graphical output 38. This is achieved by encrypting graphical output 38 with a graphical output encryption key to generate a encrypted output stream from accessory 39, that only display client software application 37 can decrypt to get contents of graphical output 38.

Display client software application 37 has a graphical output encryption and decryption module at mobile device 31. Encryption and decryption module 40 is used to decrypt graphical output 38 and encrypt user interface data.

In addition to displaying graphical output 38 display client software application 37 also captures user interface input events 41 at mobile device 31 like touch screen and keyboard 42 and transfers to accessory device 32 by using encryption and decryption module 40 to encrypt user events 41 to generate mobile device encrypted output stream 43 that is processed by accessory device 32.

Enterprise certification of display client software application 37 also enables features that prevent saving of data to mobile device local storage 44 on mobile device 31, prevent data upload to external servers 45 from mobile device 31, and prevent data capture using screen capture methods at mobile device 31.

Prior to seeing any display output from enterprise certified software applications at display client 37, a connection has to be made between mobile device 31 and accessory device 32 using one of local area network interfaces 46. In case local area network interface 46 is a wireless network interface a connection is made between mobile device 31 and accessory device 32 and the status of this indication is immediately available to a user as a hardware indicator on accessory device 32. This is done to avoid rogue access points impersonating the SSID of SSID being broadcast by accessory device 32. Hence a user who has to enter a password must first have a visual verification from accessory device 32 to verify that accessory device 32 is connected to mobile device 31 and then enter a password to establish secure communication. With this two step method, a user cannot be drawn to a rogue and untrusted access point. This is another critical aspect of present invention.

The indicator to show a connection between accessory device 32 and mobile device 31 can be shown using more than one states including connection in progress state and followed by connected state. Connection in progress may be indicated by an orange light, and once a valid password is entered, the light may change to green to indicate a secure connection between accessory device 32 and mobile device 31.

This indication can be otherwise shown using vibration or audio cues or a mix of all the above. The fact that the accessory device 32 is in proximity to the mobile device 31, it is possible for a user to verify the connection. This is not possible with conventional access points which may not be located in view of the user.

After mobile device 31 has established a connection with accessory device 32, accessory device also connects securely to an enterprise server 47 to get access to data for enterprise applications.

FIG. 2 shows accessory device 32 with a secure hardware software execution environment 48 for enterprise applications 49. Accessory device 32 provides a general purpose processor 50, an optional graphics processing unit 51, one or more mobile device networking interface 46, and one or more Internet networking interface 52.

General purpose processor 50 is used to execute enterprise applications 49 and graphics processing unit 51 is used to render graphics into frame buffer memory 53 of accessory device 32 if needed. Frame buffer memory may be implemented as shared memory across general purpose processor 50 and graphics processing unit 51.

Graphics processing unit 51 may be a separate hardware processor in addition to general purpose processor 50 or it may be part of general purpose processor 50 or it may be implemented in software as software graphics processing unit 54.

Accessory device 32 provides hardware encryption support for all enterprise application data that is stored at a secure storage 55 at accessory device 32. In addition to providing secure storage and secure network transport, accessory device 32 may include hardware processors that provide secure zones of in memory data that are inaccessible to general applications.

Secure hardware software execution environment 48 also provides a secure operating system that enables setting up encrypted file systems using hardware or software encryption methods to encrypt and decrypt any data associated with accessory device 32 and corresponding enterprise applications 49. It also offers secure boot feature 56 that prevents malware and virus like programs from being installed.

In addition to providing secure execution environment 48 for enterprise applications 49, accessory device 32 also provides a graphical output capture and export software application 57 that enables capturing graphical output 38 of enterprise applications 49 that execute in secure execution environment 48.

Captured graphical output 38 is optionally encoded as binary data using a binary encoder module 58 to generate encoded graphics output that is then passed to network serialization module 59 to generate serialized network compatible graphics output bytes. Serialized bytes are then passed to encryption module 60 to generate accessory device encrypted output stream 39 which is then transferred over one of network interfaces 46 to mobile device 31.

Mobile device encrypted output stream 43 sent from mobile device 31 to accessory device 32 is first decrypted by the decryption module 61 and then passed to the network deserialization module 62. From there, the stream is sent to binary decoder module 63 and converted to copy of user interface events 64 at accessory device 32 that are passed to general purpose processor 50. Enterprise certified software applications 49 receive output stream from general purpose processor 50 for further processing.

Secure execution environment 48 also provides accessory device management software 65 that enables secure access of accessory device 32 to information technology department of an enterprise.

Secure execution environment 48 also provides the ability to have multiple user privilege levels. Employees are provided user level privileges that enable access to enterprise applications 49 that are installed by information technology department of an enterprise. But IT department is provided with administrator level privileges that enable installing and executing accessory device management software 65. Multiple user level privileges may be supported using operating system functionality or using accessory device management software 65. Accessory device 32 is further comprised of other hardware components that enterprise applications 49 can make use of.

FIG. 3 shows accessory device 32 may be coupled to mobile device 31 as a single unit or as separate units that are located near each other within the boundaries covered by local network interface 46. Local area network interface 46 may be using wired or wireless connection.

Coupled accessory device 32 with mobile device 31 is further referred to as a coupled device. Coupled device when used as a single unit is further referred to as a combined device 66. A single unit device is formed when mobile device 31 and accessory device 32 are both physically co-located in a single housing or are attached to each other using some form of adhesion including magnetic adhesion or other forms of adhesions such as glue or Velcro. A user can carry combined device 66 as a single device and may even be provided a single charger that may be used with both devices.

Due to the proximity of the devices in combined device 66, wireless network signal strength may be automatically adjusted to the minimum power needed for the closely placed device communication. This will reduce the battery requirements for both mobile device 31 and accessory device 32.

Accessory device 32 provides cellular voice connectivity 67 using either a circuit switched or packet switched cellular voice connection. In order to support cellular voice connectivity 67, accessory device 32 may have an embedded audio circuitry including microphone 68, speaker 69, audio encoder/decoder 70, digital to analog audio converter 71, and analog to digital audio converter 72, and vocoder 73 that are connected to the cellular voice connectivity module.

Accessory device 32 also contains a subscriber identity module (SIM) card holder 74, an on and off power button and call accept and reject button 75, and several light emitting diode indicators 76 to indicate connection status with mobile device 31, battery status, power status, signal strength status and other physical status that can be programmed to illustrate different states of accessory device 32.

FIG. 4 shows components of accessory device management software 65 that enables secure installation of enterprise applications 49. Accessory device management software 65 provides standard mobile device management modules such as device audit 77, device remote wipe 78, device inventory 79, device performance reporting 80, device remote fixing 81, device remote installation 82 of new software, device tracking 83, device software upgrade 84 and device diagnostics 85.

FIG. 5 shows enterprise applications 49 that may be one of enterprise email application 86, enterprise instant messaging application 87, enterprise social networking application 88, enterprise voicemail application 89, enterprise cellular voice application 90, enterprise database application 91, enterprise office suite application 92, enterprise cloud based application 93 and enterprise in house developed application 94.

FIG. 6 shows hardware and software stack of accessory device 32 enabling multiple software programmable environments for enterprise applications 49 to use.

Accessory device 32 provides a secure programmable environment where enterprise applications 49 can be executed in a secure environment. At the lowest level, there is accessory device hardware 95 over which an operating system such as embedded linux 96 is executed. This operating system is capable of providing all secure features that an enterprise will need including multiple user support supporting different privilege levels. It may support different users such as administrator user 97 who has the capability to manage accessory device 32, regular user 98 who does not have administrator level privileges and hence cannot install any new software or hardware components, and an application user 99 is assigned to applications that are isolated from other applications so that no two applications can interact with each other without appropriate permissions.

On top of the operating system 96 a C/C++ runtime environment 100 is provided that enables applications to be executed using high level programming languages C and C++. C/C++ runtime 100 provides various libraries of code to enable messaging, string manipulation, memory management, threading and other middleware support that an application will need. This also provides common applications and software modules that other high level applications can use such as a HTTP(S) server 101, HTTP(S) proxy server, a binary encoder/decoder module 102, and a serializer and de-serializer module 103.

Above C/C++ runtime 100 accessory device may support one or more virtual machine environments such as java virtual machine 104, and javascript virtual machine 105. If virtual machine provided is an android virtual machine also known as dalvik 104, then all android applications 106 can be supported on accessory device 32. If virtual machine provided is a javascript virtual machine 105 then javascript applications 107 can be supported on accessory device 32. Native applications written in C/C++ 108 can also be supported directly.

FIG. 7 shows different types of graphical output 38 from enterprise certified mobile software applications used to render the contents onto a display of mobile device 31. Such content may include one or more of layout content 109, textual content 110, graphical primitives content 111 and bitmap content 112. Graphical primitives content 111 is comprised of two dimensional graphics content 113 and three dimensional graphics content 114. Two dimensional graphics content 113 is compatible with open standard specifications like scalable vector graphics content 115, and HTML canvas graphics 116. Three dimensional graphics content 114 is compatible with open standard specifications like opengl 117, opengeles 118, and webgl 119.

Such graphical output 38 may be captured by intercepting graphical command output from enterprise software applications 49 or by capturing bitmap content that may be generated using the optional graphics processing unit 51 at accessory device 32.

Another way to capture graphical output 38 may be to re-engineer enterprise applications to issue remote drawing commands so that enterprise applications may directly render content onto display client 37 using standard remote rendering procedures.

In addition to capture and export of graphical output, graphical output capture application 57 also provides functionality to process user interface events originating at display client 37 and dispatch these events to corresponding enterprise software applications 49.

FIG. 8 shows how accessory device 32 allows only a one page view of enterprise applications 49 on mobile device 31. Secure execution environment 48 limits the number of bytes that can be sent to display client 37 per screen based on IT department configurations. Upon page request 120 from user on mobile device 31, accessory device 32 may fetch multiple pages of data 121 from enterprise server 47 and stores it in secure storage 48. Accessory device 32 then responds by sending a single page 122 as a page response 123 to page request 120 from mobile device 31. This enables one page 122 viewing of data that may be generated as multiple pages of data 121 by enterprise applications 49. For example an enterprise application may be an office suite of application that can load a Microsoft word document that may contain a large number of pages. But since secure execution environment 48 limits the number of bytes that can be transferred to display client 37 per screen, only number of bytes to display a single page may be transferred until the user requests the next page. This eliminates the possibility that a user can download an entire document onto mobile device 31 and then upload it elsewhere. This is a critical feature of present invention that does not exist in prior art.

This limited byte transfer page display method is similar to that provided by virtual desktop infrastructure (VDI) method but has a critical difference that bits are transferred over local area network interface 46 from accessory device 32 to mobile device 31. Transferring bits using local area network reduces latency to less than five milliseconds between accessory device 32 and mobile device 31 as compared with tens of millisecond latency to a server coupled to Internet 34. Hence enterprise applications 49 that are executed at accessory device 32 will be highly interactive and responsive as compared with conventional software that is executed at a server using VDI. This is another critical advantage of present invention that is not provided by any prior art. Because of this capability, an enterprise will have maximum security for their data and applications, and a user will have the best possible user experience without server round trip delays that are present while executing software on a server machine using VDI method.

FIG. 9 shows interne networking interface 52 can be one of cellular packet data network interface 124, wireless fidelity network interface 125, satellite packet data network interface 126, packet data interface based on orthogonal frequency division multiplexing technology 127 and other terrestrial packet data interface 128.

FIG. 10 shows mobile device networking interface 46 can be one of physical electronic connection interface such as universal serial bus 129, personal area network wireless interface 130, Bluetooth network interface 131, wireless fidelity network interface 33.

FIG. 11 shows mobile device 31 can be any one of personal digital assistant 132, mobile phone 133, smart phone 134, tablet computer 135, laptop computer, 136 and portable media player 137.

FIG. 12 shows mobile device display client 37 at said mobile device can be a native application 138, a browser based application 139 or a hybrid application 140. In the case when software application 37 is a native application, an enterprise may offer this for download from an enterprise certified application store. This native application will have all the features of a secure display client mentioned above.

In case display client 37 is a browser based application 139, the browser based display client software will automatically be downloaded from accessory device 32 into the browser window and all rendering of graphics output 38 is done inside a browser. The rendering of graphics output 38 may use HTML5 standards including canvas and webgl application programming interfaces to render text, graphics, images, and three dimensional drawing content.

In case display client 37 is a hybrid application 140, the hybrid application is downloaded from an enterprise certified application store and can access native functionality of mobile device 31 and implement rendering using above mentioned HTML 5 standards using a web view widget provided by operating system of mobile device 31 that enables a browser layout engine to be embedded in any native application.

FIG. 13 and FIG. 14 illustrate the call flow sequence of a user on mobile device 31 interacting with accessory device 32.

In step 141, a user sends a connection request from mobile device 31 to accessory device 32 using local area network interface 46. If local area network interface 46 is a WiFi interface, then the user connects to a well known SSID that is published by accessory device 32.

In step 142, accessory device 32 receives and processes the connection request.

In step 143, accessory device 32 turns on hardware indicator 76 at accessory device to indicate that connection request is in progress and prompts a user to enter a password using an authentication request. A user is supposed to check for this indicator before entering a password to prevent connecting to rogue access points.

In step 144, mobile device 31 receives the authentication request.

In step 145, user fills in their credentials into authentication dialog commonly known as password dialog and submits to accessory device 32.

In step 146, accessory device 32 receives user credentials and processes credentials to match for required credentials.

In step 147, accessory device 32 checks to see if credentials have matched required credentials.

In step 148, if credentials provided by the user have been matched successfully then a server connection is made.

In step 149, enterprise server 47 receives and processes connection request from accessory device 32. This connection maybe allowed using another authentication procedure or an authentication procedure using embedded certificates at accessory device 32.

In step 150, mobile device receives authentication success and proceeds to establish a communication session using display client software 37.

In step 151, accessory device 32 receives communication request from display client and establishes a secure communication session with mobile device 31.

In step 152, accessory device denies access if credentials provided by user did not match the required credentials

In step 153, mobile device 31 receives communication establishment status as success.

In step 154, upon successful communication session establishment, accessory device 32 executes graphical capture and export module 57.

In step 155, accessory device 32 executes enterprise applications 49 that generate graphical output 38.

In step 156, graphical output of enterprise applications 38 is captured.

In step 157, graphical output 38 is converted into network ready stream of bytes 39 using serialization and this stream is optionally binary encoded and encrypted.

In step 158, network stream 39 is exported to mobile device 31, the number of bytes exported per screen is limited by IT department so that all data generated from enterprise applications 49 cannot be downloaded by mobile device as a single unit.

In step 159, network stream 39 is received by mobile device 31.

In step 160, network stream 39 is optionally decrypted, optionally decoded, and de-serialized, and rendered to converted graphical output 38 into graphical rendering or pixels representation at mobile device 31. Graphical output 38 is comprised of one or more of text data, image data, two dimensional graphics primitive data, and three dimensional graphics primitive data.

In step 161, graphical rendering is displayed onto display associated with display client 37 at mobile device 31.

In step 162, display client 37 waits for user interface events.

In step 163, user generates user interface events using display client 37.

In step 164, user interface events are converted into user interface network ready stream of bytes 43 using serialization, optional binary encoding, and optional encryption.

In step 165, user interface event stream 43 is sent to accessory device 32.

In step 166, user interface event stream 43 is received at graphics data capture and export application 57 and optionally decrypted, optionally decoded, and de-serialized to get input events that can be dispatched to enterprise applications 49.

In step 167, user interface events received are checked to see if the user wants to disconnect the communication session.

In step 168 user interface events received from display client 37 are dispatched to enterprise applications 49 if these events are not requesting disconnect.

In step 169 enterprise applications 49 receive user interface events and generate new graphical output data 38 corresponding to user interface events and the process of data capture and export to display client is repeated using step 156.

In step 170 communication session is ended as the user interface events received have a disconnect session request. This communication session can be broken using either the display client 37 or by other hardware methods such as turning off the network interface at either mobile device 31 or accessory device 32.

In step 171, a user makes a request to download all data from enterprise applications 49.

In step 172, the request above is denied since this is not allowed by IT department for security reasons.

In step 173, a user tries to save data in display client 37 into local disk at mobile device 31.

In step 174, this request is denied as this is also not allowed by IT department for security reasons.

FIG. 15 shows details of accessory device 32. Accessory device 32 is made up hardware and software components.

Accessory device 32 has a general purpose processor 50 that is part of a secure hardware software execution environment. General purpose processor 50 may provide secure boot option where only enterprise certified operating system files can be loaded into secure zones of memory associated with general purpose processor 50. General purpose processor 50 also executes a secure operating system and associated enterprise certified applications 49. General purpose processor 50 is also associated with other hardware functionality to provide additional hardware functionality to enterprise applications.

Accessory device 32 also has an optional hardware graphics processing unit 51. Graphics processing unit 51 is optional depending on the graphics capture and export application 57. In some cases graphical primitives from enterprise applications can be directly sent to display client 37, in such cases there is no need to render the graphics primitives into frame buffer associated with accessory device 32 as all the rendering of graphics primitives will be done by display client 37. Rendering is the method by which graphics primitive commands such as drawLine and drawEllipse are converted into pixels.

But in other cases where display client 37 is executing in a low powered hardware, rendering may be done using the optional graphics processing unit 51 at accessory device 32. In such cases the graphics export application 57 may capture frame buffer content output that may be from graphics processing unit 51 and export an images associated with frame buffer contents to display client 37.

In other cases there can be a hybrid approach where rendering is done at both ends, at the accessory device 32 and at the display client 37. This is needed in the cases where there are too many round trip requests from enterprise certified applications to get information about rendered bits. In such cases, if rendering is done in both devices, some of the round trip requests can be avoided by getting that information from rendered content at accessory device 32.

Graphics output capture and export application 57 is also used for receiving user interface events from display client 37 and then events these received events are dispatched to enterprise applications 49.

Accessory device 32 may be connected to mobile device 31 using local area network interfaces. These can be wired or wireless connections. Wired connections can be using a serial or parallel bus hardware architecture universal serial bus or thirty two bit parallel interface correspondingly.

In case of wireless connection, a connection in progress indicator is provided to indicate that the mobile device 31 is connected to accessory device 32 but a full communication session is not established yet.

A user is advised to check for this indication from accessory device 32 before entering a password in the password dialog. This is another critical aspect of present invention. This is particularly useful in case of wireless connectivity using 802.11 Wifi protocol where any access point may advertise an access point identifier commonly referred to as SSID. In such cases, a rouge access point may advertise itself as an access point that is associated with accessory device 32 to lure the user to connect to itself instead of the legitimate access point that accessory device 32 may advertise. The presence of connection indicator in mobile device will enable a user to verify that his/her mobile device 31 is indeed connecting to the authorized accessory device 32 and then enter the password needed to establish secure communication. Without this indicator a user may enter authentication credentials into a dialog that is associated with the rogue access point and hence lose such credentials to an unauthorized person.

Another method by which this problem is mitigated is by pre-configuring access point identifiers for accessory device 32 and not advertising these identifiers so rogue access points may not easily impersonate, such access points are also referred to as hidden access points. Here there is a smaller chance that a rogue access point may use the same SSID. But in cases where the rogue access point is able to figure out the un-advertised SSIDs, then the above indicator can help in alleviating the problem.

Another method to alleviate this problem is by using digital certificates and installing them on mobile device 31 and accessory device 32.

In such cases accessory device to enterprise server connectivity uses a digital certificate that has the credentials to allow accessory device to connect to enterprise network, and mobile device 31 has another digital certificate that allows it to connect to accessory device 32.

Accessory device 32 has hardware software secure execution environment 48 comprising secure boot, secure program execution, secure application installation, secure network access, and secure display.

Accessory device 32 is fully controlled by enterprise IT department. That is IT department holds root user or administrator level privileges. No other user including the use of mobile device 31 is granted administrator level privileges.

This enables IT department to install mobile device management software on accessory device 32 that enables IT department to install new software, audit accessory device, run performance tests, run security checks, run virus/malware scanners, backup accessory device, remotely wipe contents, distribute certificates, and install VPN software.

Accessory device 32 may have a global positioning system 54 (GPS) module so that enterprise applications can track GPS co-ordinates and offer location based services to enterprise applications.

Alternatively GPS co-ordinates may be retrieved from mobile device 31 using display client software 37 and passed to enterprise certified applications 49.

Accessory device 32 may have a camera module 175 that enables taking pictures of items such as a sales receipt that may be entered in an expense reporting enterprise application that is executing at accessory device 32.

Alternatively the camera of mobile device 31 may be used by display client software 37 to capture a video or still image and pass it to accessory device 32 for further processing by enterprise applications.

Alternatively, accessory device 32 may only have cellular voice connectivity module but may not have audio processing circuitry such as microphone, speaker. In such a case incoming voice from cellular voice connection may be routed to display client 37 at mobile device 31 for it to send the voice bits to audio circuitry at mobile device 31. Similarly, outgoing voice may be retrieved from microphone at mobile device 31 by display client 37 and then transferred to graphics capture and export application 57 at accessory device 32 which will then pass it to enterprise application related to cellular voice processing which will then send it out.

Hence display client software 37 can be used to not only display graphical output 38 of enterprise applications 49 but also enable send/receive of audio related to enterprise applications to and from mobile device 31 and send/receive video to and from mobile device 31. Similarly graphics capture and export application 57 at accessory device may have an expanded functionality to process incoming audio and video data from mobile device 31 and incoming audio/video data from external sources such as a cellular data connection or cellular voice connection.

Accessory device 32 provides a separate cellular voice and data connection using Internet networking interface 52. This enables partitioning of enterprise related calls and data usage into a separate carrier and a separated bill. This also enables enterprises to get bulk discount pricing since an enterprise can sign up with a single carrier for all employees.

Accessory device 32 may further provide a gyroscope or motion sensor 176 that can be used to operate enterprise applications based on user movement of accessory device 32 in concert with mobile device 31.

Graphics capture and export application 57 may also be enhanced to capture audio and video from enterprise applications 49 to result in an enhanced graphics capture and export application.

Audio and video captured from enterprise applications 49 are transferred to an enhanced display client 177 that is capable of processing audio and video to and from accessory device 32.

Enhanced graphics capture and export application uses audio capture module 178 and video capture modules 179. Enterprise applications can get their audio from embedded microphone 68 and convert analog audio to digital audio using analog to digital audio module 72 and then pass it to a vocoder 73 for voice processing or a music encoder 180 for music processing to get encoded audio bits that may be transferred to enhanced display client 177. The enhanced display client 177 will then process the encoded audio bits and playout using audio circuitry of mobile device 31. For example if an enterprise application is a voice memo application that has to record user audio, such audio can be recorded from embedded microphone 68 of accessory device 32 and then simultaneously be passed onto the headphone speaker of mobile device 31 through the enhanced display client 177 so that a user can hear what he is saying in the headphone speaker.

Alternatively, audio can be captured by display client 37 at mobile device and then transferred to enterprise applications 49 at accessory device 32. In such cases, accessory device 32 need not have audio processing circuitry such as microphone etc. In this case, hardware resources of mobile device 31 can be used to transfer audio data into accessory application.

Similarly, video processing can be done using an embedded camera 175 at accessory device or a camera at mobile device 31 may be used to send video or image data from mobile device 31 into enterprise certified applications 49 using enhanced display client 177 and enhanced graphics capture and export application.

Audio processing module 178 may also be used to capture audio that may be generated by enterprise applications 49 to be transferred to enhanced display client 177 instead of only processing audio from embedded microphone 68.

Video processing module 179 may be used to capture video data that may be generated by enterprise applications 49 instead of processing video data from embedded camera 175. For example, some enterprise applications 49 may decode contents of a video stream from an enterprise server and may send that stream directly to enhanced display client 177 without decoding if enhanced display client 177 is able to play it out, or else it can be decoded and rendered locally at frame buffer associated with accessory device 32 and then export contents of frame buffer to enhanced display client 177. In the case where an embedded camera 175 is used, camera input may be passed to enterprise applications 49 and then this content may be passed to enhanced display client 177 to show to user as well.

The use of embedded camera 175 and embedded audio module may be used for enterprise voice over IP or video chat like applications. Alternatively camera of mobile device and audio input from mobile device 31 may be used with enterprise applications 49 that are executing at accessory device 32.

Accessory device 32 may also have a small display for information notification purposes to enable a user to quickly get information about state of accessory device 32 or state of enterprise applications 49.

Accessory device 32 may also have a text to speech engine that enables audio output of enterprise applications 49 to be converted to audio output and be played using embedded speaker 69 or the generated audio can be forwarded to display client 37 at mobile device 31 to be played out using audio circuitry of mobile device 31.

### Advantages

From the description above a number of advantages of the BYOD solution of present invention made up of combination device comprised of a mobile device and a BYOD accessory become evident:
a) a BYOD solution is provided that addresses employee privacy issues.
b) a BYOD solution is provided that enables an employee to choose a different wireless operator that what is provided by an Enterprise.
c) a BYOD solution is provided that enables end to end hardware and software control by IT department to guarantee security.
d) a BYOD solution is provided that does not impose additional maintenance issues for IT department
e) a BYOD solution is provided that minimizes data leaks of corporate data.
f) a BYOD solution is provided that does not consume too many resources of employee owned mobile device.
g) a BYOD solution is provided that does not add unnecessary usability issues.
h) a BYOD solution is provided that enables full compatibility with E-Discovery rules
i) a BYOD solution is provided that does not add to the burden of software development teams
j) a BYOD solution is provided that provides the best application performance and the best security as in a VDI solution but without the VDI solution performance overheads.

### CONCLUSION, RAMIFICATIONS AND SCOPE

Accordingly, the reader will see that by providing a combination device comprised of a mobile device and a BYOD accessory provides a BYOD solution that does not suffer from user privacy issues, enables separate cellular connections for home and work, provides end to end control for IT department to guarantee security, minimizes maintenance issues by using one device one software platform approach, prevents data leaks, consumes minimal resources on employee owned mobile devices, does not introduce usability issues, provides for E-discovery rule compatibility, and enables highly interactive applications close to native application performance.

We claim:

1. A bring your own device system using an accessory device enabling employee owned mobile devices to be used at an enterprise, comprising:
said mobile device capable of executing personal mobile software applications;
said accessory device coupled to said mobile device wherein said accessory device is capable of executing enterprise certified mobile software applications in a secure hardware software execution environment;
said accessory device coupled to an enterprise server that is coupled to the Internet;
said mobile device further comprising a enterprise certified display client software application enabling display of graphical output of said enterprise certified mobile software applications executing at said accessory device, and enabling transfer of user interface events from said display client software application to said enterprise certified mobile software applications using said coupling between said mobile device and said accessory device;
said accessory device further comprising graphical output capture and export software application enabling capture of graphical output of said enterprise certified mobile software applications and enabling export of said captured graphical output to said display client at said mobile device using said coupling between said mobile device and said accessory device;
wherein said graphical output capture and export software application further enables reception of said user interface events from said display client software application and forward to said enterprise certified mobile software applications;
wherein number of bytes of said graphical output bytes per screen is limited by an enterprise information technology department to a configurable number such that said employee cannot download all data associated with said enterprise certified software application;
wherein said display client application at said mobile device disables saving of any data corresponding to said graphical output bytes to persistent storage associated with said mobile device;
wherein said graphical output bytes is encrypted such that only said display client application that is enterprise certified can render data associated with said graphical output bytes;
wherein said coupling between said mobile device and said accessory device is using at least one local area network interface;
wherein said coupling between said accessory device and said enterprise server is using at least one Internet networking interface;
wherein said secure hardware software execution environment at said accessory device provides secure boot, secure storage, secure program execution, secure application installation, secure network access, and secure display method that prevents bulk download of enterprise data to any other non enterprise certified device; and
wherein said accessory device is fully controlled by said enterprise by providing administrator level privileges to information technology department associated with said enterprise, and said accessory device does not provide administrator level privileges to said employee.

2. The bring your own device system using an accessory device of claim 1, wherein said accessory device is further comprised of a connection indicator that shows connection between said mobile device and said accessory device prior to entering a password for secure communication to prevent unauthorized devices from impersonating said accessory device.

3. The bring your own device system using an accessory device of claim 1, wherein said display client software application at said mobile device is selected from group consisting of native application, browser based application, and hybrid application;
wherein said graphical output of said enterprise certified mobile software applications produces a graphical rendering at said mobile device that is comprised of layout information, textual information, bitmap information, and graphical primitive information; and
wherein said graphical primitive information is comprised of at least one of two dimensional graphics primitives and three dimensional graphics primitives, wherein said two dimensional graphics primitives is compatible with open standard specifications selected from group consisting of scalable vector graphics, and HTML canvas graphics; and
wherein said three dimensional graphics primitives is compatible with open standard specifications selected from group consisting of opengl, opengeles, and webgl.

4. The bring your own device system using an accessory device of claim 3, wherein said enterprise certified display client software application is further comprised of audio and video processing software modules enabling playback of audio output, and playback of video output from said enterprise certified mobile software applications executing at said accessory device, and said audio and video processing software modules further enabling capture of audio input, and camera input associated with said mobile device and transfer said captured audio and camera input to said enterprise certified mobile software applications using said coupling between said mobile device and said accessory device.

5. The bring your own device system using an accessory device of claim 1, wherein said accessory device is comprised of a general purpose processor, an optional graphics processing unit, a secure storage unit, a mobile device networking interface, an Internet networking interface, a hardware cryptography module, and random access memory.

6. The bring your own device system using an accessory device of claim 5, wherein said accessory device is further comprised of a global positioning system, cellular voice connectivity, camera, and gyroscope enabling said enterprise certified software applications additional hardware functionality.

7. The bring your own device system using an accessory device of claim 1, wherein said enterprise certified software application is selected from group consisting of enterprise email application, enterprise instant messaging application, enterprise social networking application, enterprise voicemail application, enterprise cellular voice application, enterprise database application, enterprise office suite application, enterprise cloud based application, and enterprise in house developed application.

8. The bring your own device system using an accessory device of claim 1, wherein said mobile device is selected from group consisting of personal digital assistant, mobile phone, smart phone, tablet computer, laptop computer, and portable media player.

9. The bring your own device system using an accessory device of claim 1, wherein said Internet networking interface is selected from group consisting of cellular packet data network interface, wireless fidelity network interface, satellite packet data network interface, packet data interface based on orthogonal frequency division multiplexing technology, and other terrestrial packet data interface; and wherein said mobile device networking interface is selected from group consisting physical electronic connection interface, personal area network wireless interface, Bluetooth network interface, wireless fidelity network interface.

10. A method enabling use of employee owned mobile device at an enterprise using an accessory device comprising:
coupling said mobile device to said accessory device wherein said accessory device is capable of executing enterprise certified mobile software applications in a secure hardware software execution environment, and said mobile device is capable of executing personal mobile applications;
coupling said accessory device to an enterprise server that is coupled to the Internet;
executing at said mobile device a enterprise certified display client software application enabling display of graphical output of said enterprise certified mobile software applications executing at said accessory device, and enabling transfer of user interface events from said display client software application to said enterprise certified mobile software applications using said coupling between said mobile device and said accessory device;
executing at said accessory device a graphical output capture and export software application enabling capture of graphical output of said enterprise certified mobile software applications to export said captured graphical output to said display client at said mobile device using said coupling between said mobile device and said accessory device, and said graphical output capture and export software application further enabling reception of said user interface events from said display client software application and forwarding to said enterprise certified mobile software applications at said accessory device;
executing said enterprise certified mobile software applications at said accessory device and capturing graphical output of said enterprise certified mobile software applications into a network ready stream of graphical output bytes;
exporting said stream of graphical output bytes to said display client software application at said mobile device using said coupling between said mobile device and said accessory device;
receiving said stream of graphical output bytes at said mobile device by said display client software application;
converting said stream of graphical output bytes by said display client software application into a graphical rendering that is comprised of layout information, textual information, bitmap information, graphical primitive information;
displaying said graphical rendering onto display of said mobile device associated with said display client software application;
receiving user interface input events from said employee interacting with said display of graphical rendering at said display client software application at said mobile device;
converting said received user interface input events into a network ready stream of user interface input bytes;
transferring said stream of user interface input bytes to said graphical output capture and export software application at said accessory device using said coupling between said mobile device and said accessory device;
receiving said stream of user interface input bytes at said graphical output capture and export software application at said accessory device;
converting said received stream of user interface input bytes at said graphical output capture and export software application at said accessory device into user interface events that can be dispatched to said enterprise certified mobile software applications;
dispatching said user interface events to said enterprise certified mobile software applications;
wherein number of bytes of said network ready stream of graphical output bytes per screen is limited by an enterprise information technology department to a configurable number such that said employee cannot download all data associated with said enterprise certified software application;
wherein said display client application at said mobile device disables saving of any data corresponding to said graphical output bytes to persistent storage associated with said mobile device;
wherein said coupling between said mobile device and said accessory device is using at least one local area network interface;
wherein said coupling between said accessory device and said enterprise server is using at least one of local area network interfaces and wide area network interfaces;
wherein said secure hardware software execution environment at said accessory device provides secure boot, secure storage, secure program execution, secure application installation, secure network access, and secure software that prevents bulk download of enterprise data to any other non enterprise certified device; and
wherein said accessory device is fully controlled by said enterprise by providing administrator level privileges to information technology department associated with said enterprise, and said accessory device does not provide administrator level privileges to said employee.

11. The method enabling use of employee owned mobile device at an enterprise using an accessory device of claim 10,
wherein said coupling between said mobile device and said accessory device is comprised of connecting said mobile device to said accessory device using said local area network interface;
indicating at said mobile device using an indicator the status of said connection;
entering password at said enterprise certified display client software application at said mobile device to setup secure communication between said mobile device and said accessory device; and
wherein said indicator is selected from group consisting of light indicator, audio indicator, and vibration indicator.

12. The method enabling use of employee owned mobile device at an enterprise using an accessory device of claim 10, wherein said display client software application at said mobile device is selected from group consisting of native application, browser based application, and hybrid application; wherein said graphical output of said enterprise certified mobile software applications produces a graphical rendering at said mobile device that is comprised of layout information, textual information, bitmap information, and graphical primitive information; and
wherein said graphical primitive information is comprised of at least one of two dimensional graphics primitives and three dimensional graphics primitive, wherein said three dimensional graphics primitives is compatible with open standard specifications selected from group consisting of opengl, opengeles, and webgl.

13. The method enabling use of employee owned mobile device at an enterprise using an accessory device of claim 10, wherein said enterprise certified display client software application is further comprised of audio and video processing software modules enabling playback of audio output, and playback of video output from said enterprise certified mobile software applications executing at said accessory device, and said audio and video processing software modules further enabling capture of audio input, and camera input associated with said mobile device and transfer said captured audio and camera input to said enterprise certified mobile software applications using said coupling between said mobile device and said accessory device.

14. The method enabling use of employee owned mobile device at an enterprise using an accessory device of claim 10, wherein said accessory device is comprised of a general purpose processor, an optional graphics processing unit, a secure storage unit, a mobile device networking interface, an Internet networking interface, a hardware cryptography module, and random access memory.

15. The method enabling use of employee owned mobile device at an enterprise using an accessory device of claim 10, wherein said mobile device is selected from group consisting of personal digital assistant, mobile phone, smartphone, tablet computer, laptop computer, and portable media player.

16. The method enabling use of employee owned mobile device at an enterprise using an accessory device of claim 10, wherein said Internet networking interface is selected from group consisting of cellular packet data network interface, wireless fidelity network interface, satellite packet data network interface, packet data interface based on orthogonal frequency division multiplexing technology, and other terrestrial packet data interface.

17. The method enabling use of employee owned mobile device at an enterprise using an accessory device of claim 10, wherein said mobile device networking interface is selected from group consisting physical electronic connection interface, personal area network wireless interface, Bluetooth network interface, wireless fidelity network interface.

18. An accessory device to a employee owned mobile device enabling bring your own device functionality to said mobile device such that said mobile device can be used at an enterprise using said accessory device as a gateway into said enterprise, comprising:
general purpose processor capable of executing enterprise certified mobile software applications in a secure hardware software execution environment;
graphics processing unit capable of rendering graphics output of said enterprise certified mobile software applications into a frame buffer associated with said graphics processing unit;
at least one mobile device networking interface coupling said accessory device to said mobile device;
at least one Internet networking interface selected from group consisting of local area network interface and wide area network interface;
graphical output capture and export software application enabling capture of graphical output of said enterprise certified mobile software applications and enabling export of said captured graphical output to a enterprise certified display client at said mobile device using said coupling between said mobile device and said accessory device;
wherein said graphical output capture and export software application further enables reception of said user interface events from said display client software application and forward to said enterprise certified mobile software applications;
wherein said secure hardware software execution environment at said accessory device provides secure boot, secure storage, secure program execution, secure application installation, secure network access, and secure display method that prevents bulk download of enterprise data to any other non enterprise certified device;
wherein said accessory device is fully controlled by said enterprise by providing administrator level privileges to information technology department associated with said enterprise, and said accessory device does not provide administrator level privileges to said employee.

19. The accessory device of claim 18, wherein said accessory device is further comprised of a connection indicator that shows connection between said mobile device and said accessory device prior to entering a password for secure communication to prevent unauthorized devices from impersonating said accessory device.

20. The accessory device of claim 18, wherein said accessory device is further comprised of a global positioning system, cellular voice connectivity, camera, and gyroscope enabling said enterprise certified software applications additional hardware functionality.

21. The accessory device of claim 18, wherein said graphical output capture and export software application is further comprised of audio and video processing software modules enabling dispatch of audio, video from said display client software application to said enterprise certified applications, and further enabling capture of audio, video output of said enterprise certified applications and transfer to said display client software application at said mobile device.

22. The accessory device of claim 18, wherein said mobile device is selected from group consisting of personal digital assistant, mobile phone, smartphone, tablet computer, laptop computer, and portable media player.

23. The accessory device of claim 18, wherein said Internet networking interface is selected from group consisting of cellular packet data network interface, wireless fidelity network interface, satellite packet data network interface, packet data interface based on orthogonal frequency division multiplexing technology, and other terrestrial packet data interface;
wherein said mobile device networking interface is selected from group consisting physical electronic connection interface, personal area network wireless interface, Bluetooth network wireless interface, wireless fidelity network interface.

24. The accessory device of claim 18, wherein said graphical output of said enterprise certified mobile software applications produces a graphical rendering at said mobile device that is comprised of layout information, textual information, bitmap information, and graphical primitive information; and wherein said graphical primitive information is comprised of at least one of two dimensional graphics primitives and three dimensional graphics primitive, wherein said three dimensional graphics primitives is compatible with open standard specifications selected from group consisting of opengl, opengeles, and webgl.
